(19) United States
(12) Patent Application Publication
(10) Pub. No.: US 2016/0334660 A1
(43) Pub. Date: Nov. 17, 2016

(54) IN-CELL TOUCH PANEL

(71) Applicant: Raydium Semiconductor Corporation, Hsinchu (TW)

(72) Inventors: Yi-Ying LIN, Hualien City (TW); Kun-Pei LEE, Zhunan Township (TW); Chang-Ching CHIANG, Taichung City (TW)

(21) Appl. No.: 15/154,213

(22) Filed: May 13, 2016

Related U.S. Application Data
(63) Continuation-in-part of application No. 14/882,880, filed on Oct. 14, 2015.
(60) Provisional application No. 62/162,238, filed on May 15, 2015.

(51) Int. Cl. G02F 1/1333; G02F 1/1343; G02F 1/1368; G02F 1/1335; G06F 3/041; G06F 3/044

(52) U.S. Cl. CPC G02F 1/13338; G06F 3/0412; G06F 3/044; G06F 3/0416; G02F 1/1368; G02F 1/133514; G02F 1/134309; G06F 2203/04112; G02F 2001/133302

(57) ABSTRACT

An in-cell touch panel is disclosed. The in-cell touch panel includes a plurality of pixels. A laminated structure of each pixel includes a substrate, a TFT layer, a liquid crystal layer, a color filter layer, a glass layer and a second conductive layer. The TFT layer is disposed on the substrate. A first conductive layer and a common electrode are disposed in the TFT layer. The first conductive layer is arranged in mesh type. The liquid crystal layer is disposed above the TFT layer. The color filter layer is disposed above the liquid crystal layer. The glass layer is disposed above the color filter layer. The second conductive layer is disposed above the glass layer.

### BACKGROUND OF THE INVENTION

1. Field of the Invention

This invention relates to a touch panel, especially to an in-cell touch panel.

2. Description of the Related Art

Please refer to FIG. 1. FIG. 1 illustrates a laminated structure of a conventional on-cell capacitive touch panel. As shown in FIG. 1, the laminated structure 1 of the conventional on-cell capacitive touch panel includes a substrate 10, a thin-film transistor layer 11, a liquid crystal layer 12, a color filter layer 13, a glass layer 14, a touch sensing layer 15, a polarizer 16, an adhesive 17, and top cover lens 18.

From FIG. 1, it can be found that the touch sensing layer 15 of the on-cell capacitive touch panel is disposed above the glass layer 14; that is to say, the touch sensing layer 15 is disposed out of the liquid crystal display module of the on-cell capacitive touch panel. Compared to the conventional one glass solution (OGS), the on-cell capacitive touch panel can achieve thinner touch panel design; however, the on-cell capacitive touch panel cannot meet the thinnest thickness requirement of the novel portable electronic products such as mobile phones, tablet PCs, and notebooks.

### SUMMARY OF THE INVENTION

Therefore, the invention provides an in-cell touch panel to solve the above-mentioned problems.

A preferred embodiment of the invention is an in-cell touch panel. In this embodiment, the in-cell touch panel includes a plurality of pixels. A laminated structure of each pixel includes a substrate, a TFT layer, a liquid crystal layer, a color filter layer, a glass layer and a second conductive layer. The TFT layer is disposed on the substrate. A first conductive layer and a common electrode are disposed in the TFT layer. The first conductive layer is arranged in mesh type. The liquid crystal layer is disposed above the TFT layer. The color filter layer is disposed above the liquid crystal layer. The glass layer is disposed above the color filter layer. The second conductive layer is disposed above the glass layer.

In an embodiment, the in-cell touch panel is an in-cell mutual-capacitive touch panel, touch electrodes of the in-cell mutual-capacitive touch panel includes a first direction electrode and a second direction electrode, the first direction electrode is formed by the first conductive layer arranged in mesh type and the second direction electrode is formed by the second conductive layer.

In an embodiment, the second conductive layer is formed by transparent conductive material.

In an embodiment, the first conductive layer is formed after the common electrode is formed.

In an embodiment, the first conductive layer is formed before the common electrode is formed.

In an embodiment, the color filter layer includes a color filter and a black matrix resist, the black matrix resist has good light resistance, and the first conductive layer is disposed under the black matrix resist.

In an embodiment, the thin-film transistor layer further includes an original conductive layer; the original conductive layer is electrically connected with the common electrode to be traces of the common electrode to reduce RC loading of the common electrode.

In an embodiment, the first direction electrode and the second direction electrode are a driving electrode (TX) and a sensing electrode (RX) respectively or the first direction electrode and the second direction electrode are the sensing electrode (RX) and the driving electrode (TX) respectively.

In an embodiment, region dividing of the touch electrodes of the in-cell mutual-capacitive touch panel is determined by connection or disconnection of the first conductive layer.

In an embodiment, a part of the first conductive layer not forming the first direction electrode is electrically connected with the common electrode to be traces of the common electrode to reduce RC loading of the common electrode.

In an embodiment, the part of the first conductive layer not forming the first direction electrode is disposed in a vacancy region between the touch electrodes to be electrically connected with the common electrode.

In an embodiment, a gate line and another gate line in the thin-film transistor layer are adjacently aligned at one side of the pixel.

In an embodiment, a part of the first conductive layer not forming the first direction electrode or an original conductive layer in the thin-film transistor layer is disposed at another side of the pixel and electrically connected with the common electrode to be traces of the common electrode to reduce RC loading of the common electrode.

In an embodiment, when the laminated structure has a half source driving (HSD) structure, the laminated structure includes an additional vacated source line space.

In an embodiment, an original conductive layer in the thin-film transistor layer is electrically connected with the first conductive layer within the additional vacated source line space to be traces of the first direction electrode.

In an embodiment, an original conductive layer in the thin-film transistor layer is electrically connected with the common electrode within the additional vacated source line space to be traces of the common electrode to reduce RC loading of the common electrode.

In an embodiment, a dummy electrode is disposed between the second direction electrodes formed by the second conductive layer, and the dummy electrode is in a floating state.

In an embodiment, when the in-cell touch panel is operated in a touch mode, the common electrode is switched to a floating state or provided a touch related signal.

In an embodiment, a touch mode and a display mode of the in-cell touch panel are driven in a time-sharing way; the in-cell touch panel is operated in the touch mode during a blanking interval of a display period.

In an embodiment, the blanking interval includes at least one of a vertical blanking interval (VBI), a horizontal blanking interval (HBI), and a long horizontal blanking interval (LHBI); a time length of the LHBI is equal to or larger than a time length of the HBI; the LHBI is obtained by redistributing a plurality of HBIs or the LHBI includes the VBI.

In an embodiment, the common electrode has a plurality of common electrode regions overlapped with a plurality of touch electrodes of the in-cell touch panel respectively; when the in-cell touch panel is operated in the touch mode, the plurality of touch electrodes is provided a plurality of touch signals in order and the common electrode is provided a plurality of touch related signals having the same frequency, the same amplitude or the same phase with the plurality of touch signals in order correspondingly or the common electrode is in a floating state.

In an embodiment, the common electrode has a common electrode region overlapped with a plurality of touch electrodes of the in-cell touch panel simultaneously; when the in-cell touch panel is operated in the touch mode, the plurality of touch electrodes is provided a touch signal and the common electrode is provided a touch related signal having the same frequency, the same amplitude or the same phase with the touch signal or the common electrode is in a floating state.

Compared to the prior arts, the in-cell touch panel of the invention has the following advantages and effects:

(1) Designs of the touch electrodes and their traces in the in-cell touch panel of the invention are simple.

(2) The original aperture ratio of the in-cell touch panel will not affected by the layout method of the invention.

(3) The RC loading of the common electrode can be reduced.

(4) When the in-cell touch panel is operated in touch mode, the common electrode is controlled simultaneously to reduce entire RC loading of the in-cell touch panel.

(5) The touch mode and the display mode of the in-cell touch panel are driven in a time-sharing way to enhance the signal-noise ratio (SNR). The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic diagram of the laminated structure of the conventional on-cell capacitive touch panel.

FIG. 2 illustrates a schematic diagram of touch electrode layout of the in-cell mutual-capacitive touch panel in an embodiment of the invention.

FIG. 3A illustrates a cross-sectional schematic diagram of the laminated structure of the in-cell mutual-capacitive touch panel in the first embodiment of the invention; FIG. 3B illustrates a schematic diagram of the pixel design of the in-cell mutual-capacitive touch panel of FIG. 3A.

FIG. 4A illustrates a cross-sectional schematic diagram of the laminated structure of the in-cell mutual-capacitive touch panel in the second embodiment of the invention; FIG. 4B illustrates a schematic diagram of the pixel design of the in-cell mutual-capacitive touch panel of FIG. 4A.

FIG. 5A illustrates a cross-sectional schematic diagram of the laminated structure of the in-cell mutual-capacitive touch panel in the third embodiment of the invention; FIG. 5B illustrates a schematic diagram of the pixel design of the in-cell mutual-capacitive touch panel of FIG. 5A.

FIG. 6A illustrates a cross-sectional schematic diagram of the laminated structure of the in-cell mutual-capacitive touch panel in the fourth embodiment of the invention; FIG. 6B illustrates a schematic diagram of the pixel design of the in-cell mutual-capacitive touch panel of FIG. 6A.

FIG. 7 illustrates a schematic diagram of the pixel design of the in-cell mutual-capacitive touch panel when the laminated structure of the in-cell mutual-capacitive touch panel having the HSD structure.

FIG. 8A and FIG. 8B illustrate schematic diagrams of different layout patterns of the touch electrodes of the in-cell mutual-capacitive touch panel respectively.

FIG. 9 illustrates a schematic diagram of dummy electrodes disposed between the second direction electrodes formed by the second conductive layer.

FIG. 10A illustrates a schematic diagram of the in-cell mutual-capacitive touch panel operated in the touch mode by outputting touch driving signals during the blanking interval of the image signal; FIG. 10B illustrates a schematic diagram of the vertical blanking interval (VBI), the horizontal blanking interval (HBI), and the long horizontal blanking interval respectively.

FIG. 11A illustrates a schematic diagram of the common electrodes of the in-cell mutual-capacitive touch panel having a plurality of common electrode regions overlapped with the plurality of touch electrodes respectively; FIG. 11B illustrates a timing diagram that when the in-cell mutual-capacitive touch panel is operated in the touch mode, the plurality of touch electrodes is provided a plurality of touch signals in order and the plurality of common electrode regions of the common electrode is provided a plurality of touch related signals having the same frequency, the same amplitude or the same phase with the plurality of touch signals in order correspondingly; FIG. 11C illustrates a timing diagram that when the in-cell mutual-capacitive touch panel is operated in the touch mode, the plurality of touch electrodes is provided a plurality of touch signals in order and the plurality of common electrode regions of the common electrode is in a floating state.

FIG. 12A illustrates a schematic diagram of the common electrodes of the in-cell mutual-capacitive touch panel having a common electrode region overlapped with the plurality of touch electrodes simultaneously; FIG. 12B illustrates a timing diagram that when the in-cell mutual-capacitive touch panel is operated in the touch mode, the plurality of touch electrodes is provided a plurality of touch signals in order and the common electrode is provided a touch related signal having the same frequency, the same amplitude or the same phase with the plurality of touch signals; FIG. 12C illustrates a timing diagram that when the in-cell mutual-capacitive touch panel is operated in the touch mode, the plurality of touch electrodes is provided a plurality of touch signals in order and the common electrode is in a floating state.

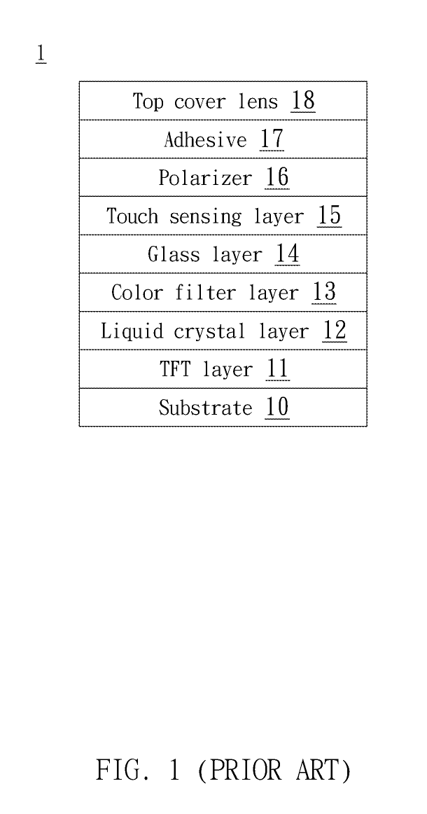

### DETAILED DESCRIPTION

A preferred embodiment of the invention is an in-cell touch panel. In practical applications, the in-cell touch panel can be an in-cell mutual-capacitive touch panel, but not limited to this.

In this embodiment, the in-cell touch panel includes a plurality of pixels. A laminated structure of each pixel includes a substrate, a TFT layer, a liquid crystal layer, a color filter layer, a glass layer and a second conductive layer. The TFT layer is disposed on the substrate. A first conductive layer and a common electrode are disposed in the TFT layer. The first conductive layer is arranged in mesh type. The liquid crystal layer is disposed above the TFT layer. The color filter layer is disposed above the liquid crystal layer. The glass layer is disposed above the color filter layer. The second conductive layer formed by transparent conductive material is disposed above the glass layer.

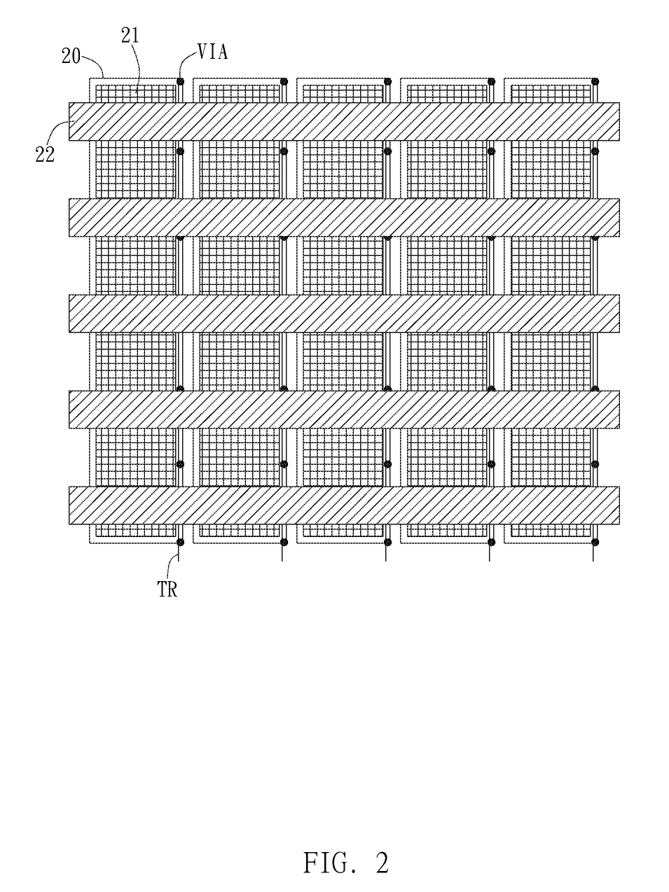

Please refer to FIG. 2. FIG. 2 illustrates a schematic diagram of touch electrode layout of the in-cell mutual-capacitive touch panel in an embodiment of the invention. As shown in FIG. 2, touch electrodes of the in-cell mutual-capacitive touch panel includes a first direction electrode 21 and a second direction electrode 22. The first direction electrode 21 is formed by the first conductive layer arranged in mesh type and the second direction electrode 22 is formed by the second conductive layer.

In fact, the first direction electrode 21 and the second direction electrode 22 can be a driving electrode (TX) and a sensing electrode (RX) respectively or the first direction electrode 21 and the second direction electrode 22 can be the sensing electrode (RX) and the driving electrode (TX) respectively without any specific limitations.

It should be noticed that the first conductive layer and the common electrode 20 are disposed in the TFT layer and the second conductive layer is disposed above the TFT layer; therefore, the second conductive layer will be located above the first conductive layer. That is to say, the second direction electrode 22 formed by the second conductive layer will be located above the first direction electrode 21 formed by the first conductive layer.

In addition, common electrode traces TR are electrically connected with the common electrodes 20 through the via VIA to reduce RC loading of the common electrodes 20. In fact, the common electrode traces TR can be formed by a part of first conductive layer not forming the first direction electrode 21 or other original conductive layer in the TFT layer, but not limited to this.

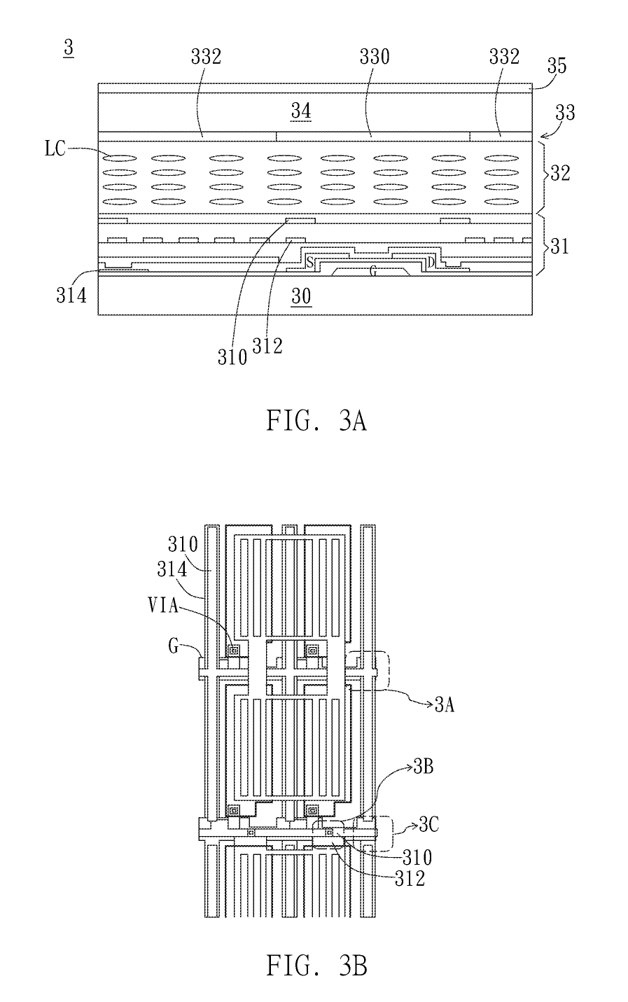

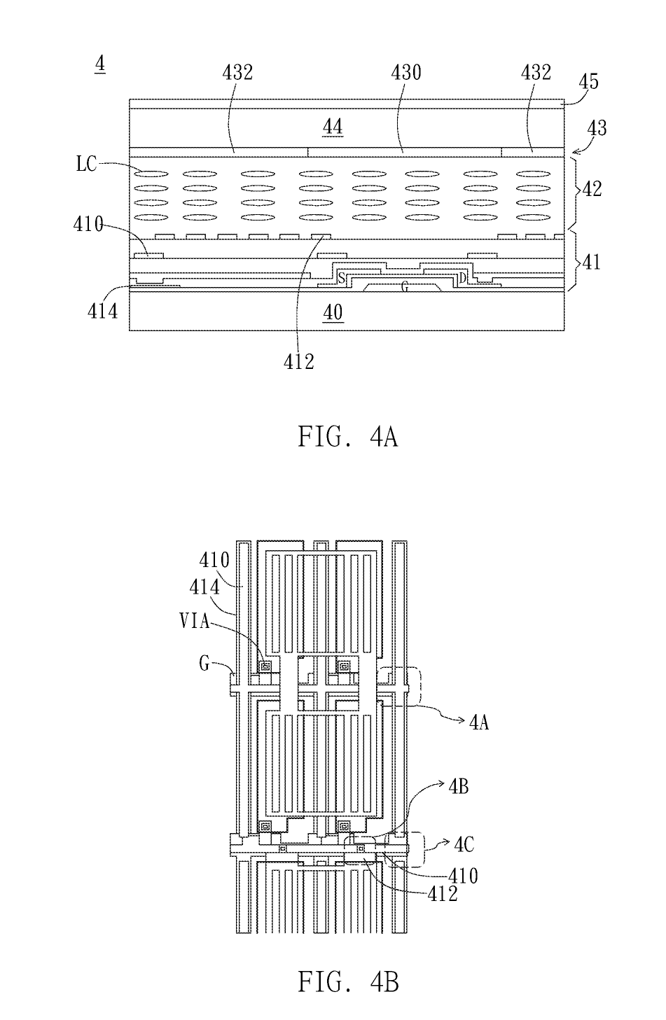

Then, please refer to FIG. 3A. FIG. 3A illustrates a cross-sectional schematic diagram of the laminated structure of the in-cell mutual-capacitive touch panel in the first embodiment of the invention. As shown in FIG. 3A, the laminated structure 3 of the in-cell mutual-capacitive touch panel includes a substrate 30, a thin-film transistor (TFT) layer 31, a liquid crystal layer 32, a color filter layer 33, a glass layer 34, and a second conductive layer 35. The TFT layer 31 is disposed on the substrate 30. A first conductive layer 310 and a common electrode 312 are disposed in the TFT layer 31 and the first conductive layer 310 is formed after the common electrode 312 is formed. The first conductive layer 310 is arranged in mesh type. The liquid crystal layer 32 including a plurality of liquid crystal units LC is disposed above the TFT layer 31. The color filter layer 33 is disposed above the liquid crystal layer 32. The glass layer 34 is disposed above the color filter layer 33. The second conductive layer 35 is disposed above the glass layer 34.

It should be noticed that the color filter layer 33 includes a black matrix resist 330 and a color filter 332. The first conductive layer 310 arranged in mesh type is disposed under the black matrix resist 330, so that the black matrix resist 330 having good light resistance can shield the underlying first conductive layer 310.

Please also refer to FIG. 3B. FIG. 3B illustrates a schematic diagram of the pixel design of the in-cell mutual-capacitive touch panel of FIG. 3A. As shown in FIG. 3B, the region dividing of the touch electrodes of the in-cell mutual-capacitive touch panel is determined by connection or disconnection of the first conductive layer 310.

For example, in the dotted-line range 3A, the first conductive layer 310 is connected, so that the upper pixel and the lower pixel belong to the same touch electrode region; in the dotted-line range 3C, the first conductive layer 310 is disconnected, so that the upper pixel and the lower pixel belong to different touch electrode regions. In addition, in the dotted-line range 3B, a part of the first conductive layer 310 not forming the first direction electrode can be disposed at a vacancy region between the touch electrodes and the part of the first conductive layer 310 can be electrically connected with the common electrode 312 through the via VIA, but not limited to this.

Then, please refer to FIG. 4A. FIG. 4A illustrates a cross-sectional schematic diagram of the laminated structure of the in-cell mutual-capacitive touch panel in the second embodiment of the invention. As shown in FIG. 4A, the laminated structure 4 of the in-cell mutual-capacitive touch panel includes a substrate 40, a TFT layer 41, a liquid crystal layer 42, a color filter layer 43, a glass layer 44, and a second conductive layer 45. The TFT layer 41 is disposed on the substrate 40. A first conductive layer 410 and a common electrode 412 are disposed in the TFT layer 41 and the first conductive layer 410 is formed before the common electrode 412 is formed. The first conductive layer 410 is arranged in mesh type. The liquid crystal layer 42 including a plurality of liquid crystal units LC is disposed above the TFT layer 41. The color filter layer 43 is disposed above the liquid crystal layer 42. The glass layer 44 is disposed above the color filter layer 43. The second conductive layer 45 is disposed above the glass layer 44.

It should be noticed that the color filter layer 43 includes a black matrix resist 430 and a color filter 432. The first conductive layer 410 arranged in mesh type is disposed under the black matrix resist 430, so that the black matrix resist 430 having good light resistance can shield the underlying first conductive layer 410.

Please also refer to FIG. 4B. FIG. 4B illustrates a schematic diagram of the pixel design of the in-cell mutual-capacitive touch panel of FIG. 4A. As shown in FIG. 4B, the region dividing of the touch electrodes of the in-cell mutual-capacitive touch panel is determined by connection or disconnection of the first conductive layer 410.

For example, in the dotted-line range 4A, the first conductive layer 410 is connected, so that the upper pixel and the lower pixel belong to the same touch electrode region; in the dotted-line range 4C, the first conductive layer 410 is disconnected, so that the upper pixel and the lower pixel belong to different touch electrode regions. In addition, in the dotted-line range 4B, a part of the first conductive layer 410 not forming the first direction electrode can be disposed at a vacancy region between the touch electrodes and the part of the first conductive layer 410 can be electrically connected with the common electrode 412 through the via VIA, but not limited to this.

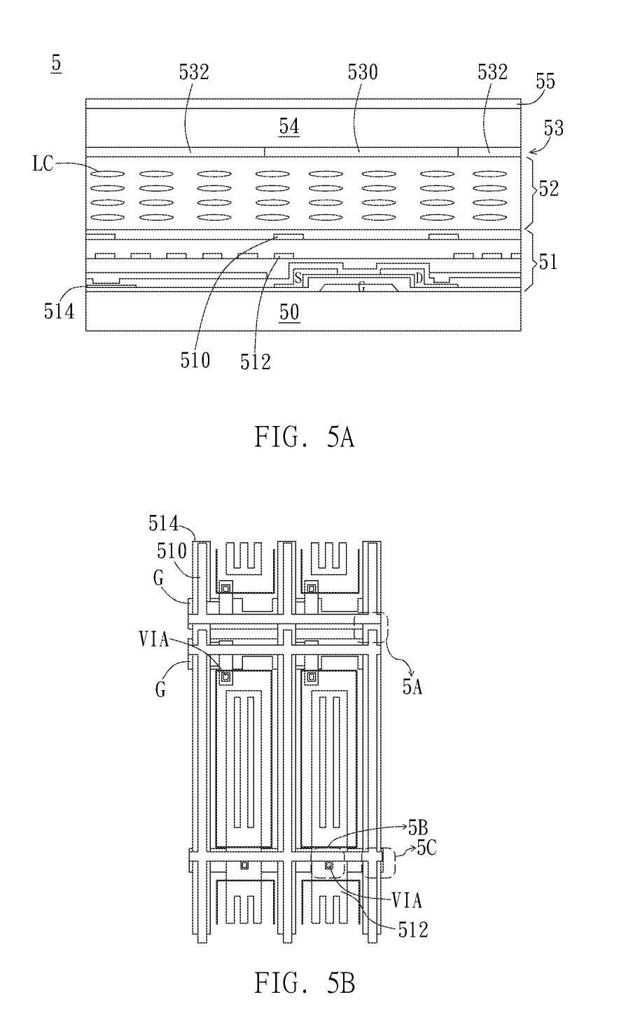

Then, please refer to FIG. 5A. FIG. 5A illustrates a cross-sectional schematic diagram of the laminated structure of the in-cell mutual-capacitive touch panel in the third embodiment of the invention. As shown in FIG. 5A, the laminated structure 5 of the in-cell mutual-capacitive touch panel includes a substrate 50, a TFT layer 51, a liquid crystal layer 52, a color filter layer 53, a glass layer 54, and a second conductive layer 55. The TFT layer 51 is disposed on the substrate 50. A first conductive layer 510 and a common electrode 512 are disposed in the TFT layer 51 and the first conductive layer 510 is formed after the common electrode 512 is formed. The first conductive layer 510 is arranged in mesh type. The liquid crystal layer 52 including a plurality of liquid crystal units LC is disposed above the TFT layer 51. The color filter layer 53 is disposed above the liquid crystal layer 52. The glass layer 54 is disposed above the color filter layer 53. The second conductive layer 55 is disposed above the glass layer 54.

It should be noticed that the color filter layer 53 includes a black matrix resist 530 and a color filter 532. The first conductive layer 510 arranged in mesh type is disposed under the black matrix resist 530, so that the black matrix resist 530 having good light resistance can shield the underlying first conductive layer 510.

Please also refer to FIG. 5B. FIG. 5B illustrates a schematic diagram of the pixel design of the in-cell mutual-capacitive touch panel of FIG. 5A. As shown in FIG. 5B, the region dividing of the touch electrodes of the in-cell mutual-capacitive touch panel is determined by connection or disconnection of the first conductive layer 510.

For example, in the dotted-line range 5A, the first conductive layer 510 is disconnected, so that the upper pixel and the lower pixel belong to different touch electrode regions; in the dotted-line range 5C, the first conductive layer 310 is connected, so that the upper pixel and the lower pixel belong to the same touch electrode region. In addition, in the dotted-line range 5B, a conductive layer (e.g., the gate conductive layer G) not forming the touch electrode can be electrically connected with the common electrode 512 through the via VIA, but not limited to this.

It should be noticed that, as shown in FIG. 5B, two gate lines G in the thin-film transistor layer can be adjacently aligned at one side of the pixel, so that the width of the black matrix resist disposed above the thin-film transistor layer can be reduced accordingly. In addition, a part of the first conductive layer 510 not forming the first direction electrode or an original conductive layer in the thin-film transistor layer can be disposed at another side of the pixel and electrically connected with the common electrode 512 to be traces of the common electrode 512 to reduce RC loading of the common electrode 512.

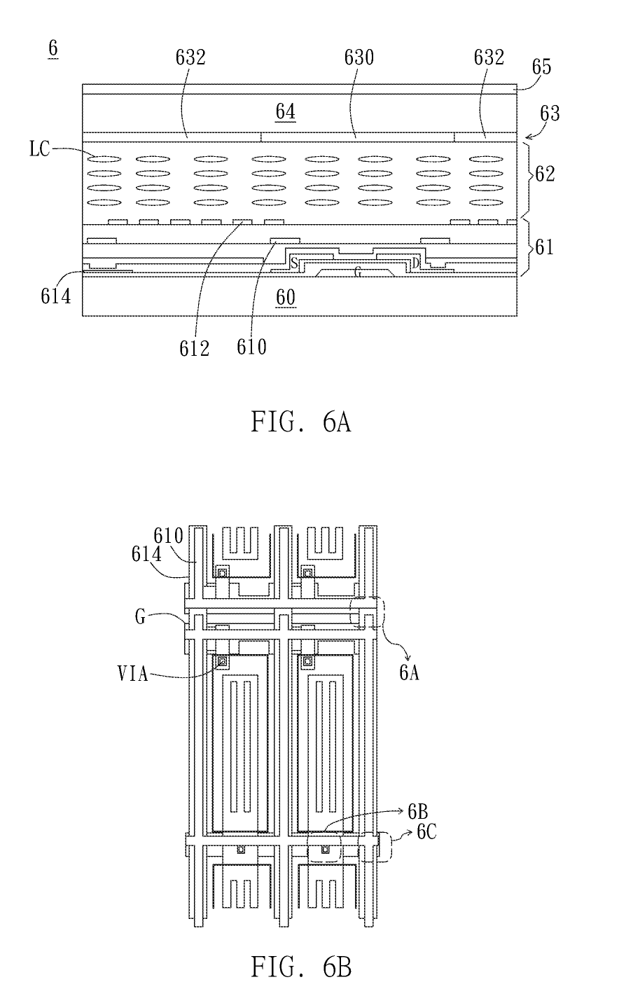

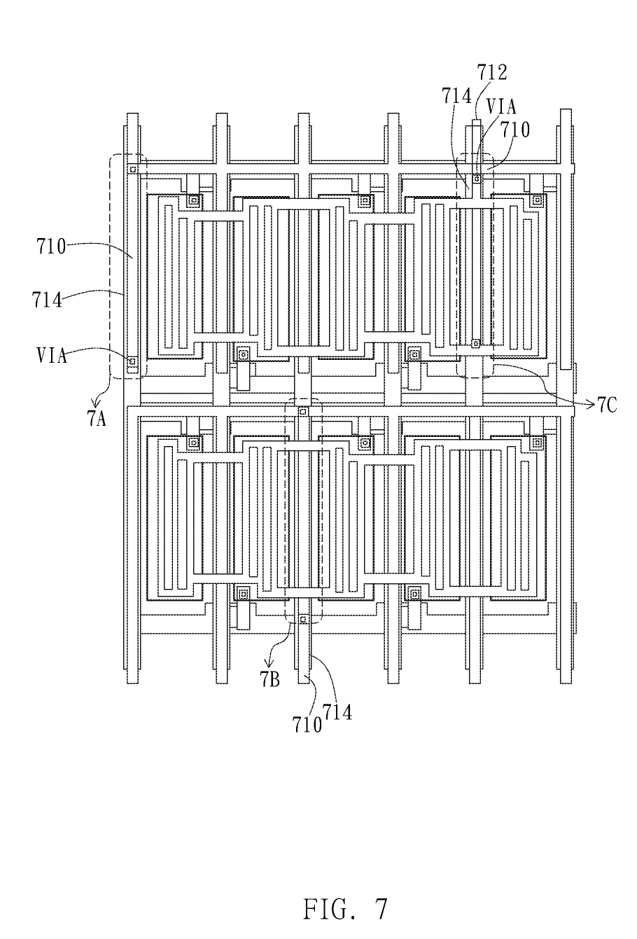

Then, please refer to FIG. 6A. FIG. 6A illustrates a cross-sectional schematic diagram of the laminated structure of the in-cell mutual-capacitive touch panel in the fourth embodiment of the invention. As shown in FIG. 6A, the laminated structure 6 of the in-cell mutual-capacitive touch panel includes a substrate 60, a TFT layer 61, a liquid crystal layer 62, a color filter layer 63, a glass layer 64, and a second conductive layer 65. The TFT layer 61 is disposed on the substrate 60. A first conductive layer 610 and a common electrode 612 are disposed in the TFT layer 61 and the first conductive layer 610 is formed before the common electrode 612 is formed. The first conductive layer 610 is arranged in mesh type. The liquid crystal layer 62 including a plurality of liquid crystal units LC is disposed above the TFT layer 61. The color filter layer 63 is disposed above the liquid crystal layer 62. The glass layer 64 is disposed above the color filter layer 63. The second conductive layer 65 is disposed above the glass layer 64.

It should be noticed that the color filter layer 63 includes a black matrix resist 630 and a color filter 632. The first conductive layer 610 arranged in mesh type is disposed under the black matrix resist 630, so that the black matrix resist 630 having good light resistance can shield the underlying first conductive layer 610.

Please also refer to FIG. 6B. FIG. 6B illustrates a schematic diagram of the pixel design of the in-cell mutual-capacitive touch panel of FIG. 6A. As shown in FIG. 6B, the region dividing of the touch electrodes of the in-cell mutual-capacitive touch panel is determined by connection or disconnection of the first conductive layer 610.

For example, in the dotted-line range 6A, the first conductive layer 610 is disconnected, so that the upper pixel and the lower pixel belong to different touch electrode regions; in the dotted-line range 6C, the first conductive layer 610 is connected, so that the upper pixel and the lower pixel belong to the same touch electrode region. In addition, in the dotted-line range 6B, a conductive layer (e.g., the gate conductive layer G) not forming the touch electrodes can be electrically connected with the common electrode 612 through the via VIA, but not limited to this.

It should be noticed that, as shown in FIG. 6B, two gate lines G in the thin-film transistor layer can be adjacently aligned at one side of the pixel, so that the width of the black matrix resist disposed above the thin-film transistor layer can be reduced accordingly. In addition, a part of the first conductive layer 610 not forming the first direction electrode or an original conductive layer in the thin-film transistor layer can be disposed at another side of the pixel and electrically connected with the common electrode 612 to be traces of the common electrode 612 to reduce RC loading of the common electrode 612.

Then, please refer to FIG. 7. When the laminated structure has a half source driving (HSD) structure, the laminated structure includes an additional vacated source line space. In the dotted-line ranges 7A and 7B, an original conductive layer in the thin-film transistor layer is electrically connected with the first conductive layer 710 within the additional vacated source line space to be traces of the touch electrodes (e.g., the first direction electrodes) formed by the first conductive layer 710. In addition, in the dotted-line range 7C, an original conductive layer in the thin-film transistor layer is electrically connected with the common electrode 712 within the additional vacated source line space to be traces of the common electrode 712 to reduce RC loading of the common electrode 712.

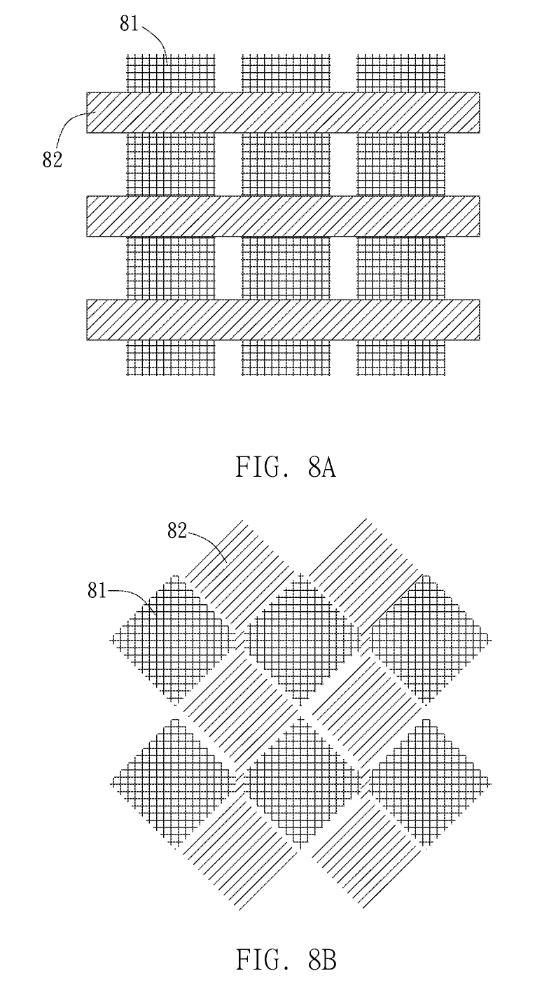

In practical applications, as shown in FIG. 8A and FIG. 8B, the touch electrodes of the in-cell mutual-capacitive touch panel includes a first direction electrode 81 and a second direction electrode 82. The first direction electrode 81 is formed by the first conductive layer arranged in mesh type and the second direction electrode 82 is formed by the second conductive layer. The second direction electrode 82 is located above the first direction electrode 81.

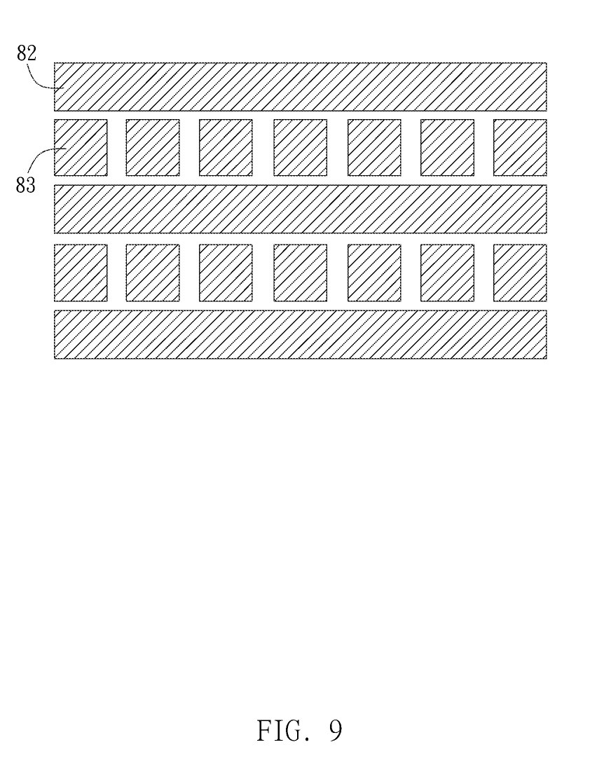

It should be noticed that there is no limitations to the touch electrode patterns of the in-cell mutual-capacitive touch panel of the invention; therefore, the arrangement and layout of the first direction electrode 81 and the second direction electrode 82 can be designed as FIG. 8A, FIG. 8B or other arrangements and layouts without any specific limitations. In addition, as shown in FIG. 9, dummy electrodes 83 can be disposed between the second direction electrodes 82 formed by the second conductive layer and the dummy electrodes 83 can be in the floating state, but not limited to this.

The in-cell mutual-capacitive touch panel of the invention can be operated in the display mode or the touch mode at different times respectively; that is to say, the display mode and the touch mode of the in-cell mutual-capacitive touch panel of the invention are driven in a time-sharing way.

When the in-cell mutual-capacitive touch panel is operated in the display mode, its gate driver and source driver will output gate driving signals G1˜G3 and source driving signals S1˜S3 respectively to drive the pixels of the in-cell mutual-capacitive touch panel to display image. When the in-cell mutual-capacitive touch panel is operated in a touch mode, the common electrode of the in-cell mutual-capacitive touch panel can be switched to the floating state or provided a touch related signal, but not limited to this.

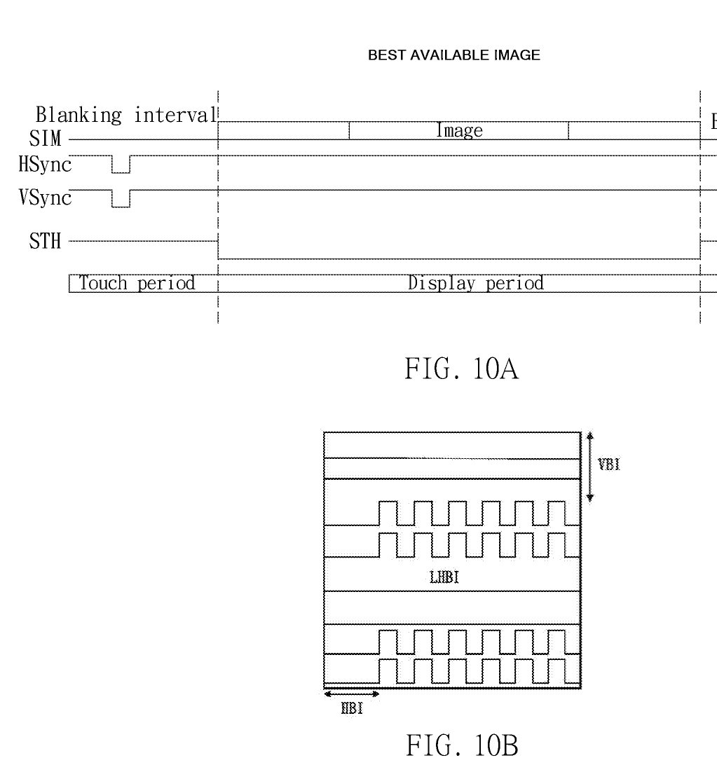

Please refer to FIG. 10A. As shown in FIG. 10A, the in-cell mutual-capacitive touch panel 10A is operated in the touch mode by outputting the touch driving signals STH during a blanking interval of the image signal SIM. The in-cell mutual-capacitive touch panel 10A will perform touch sensing during the non-display timing (e.g., the blanking interval). Please also refer to FIG. 10B. FIG. 10B illustrates a schematic diagram of the vertical blanking interval (VBI), the horizontal blanking interval (HBI), and the long horizontal blanking interval respectively. In practical applications, the in-cell mutual-capacitive touch panel can use different kinds of blanking intervals based on different driving ways. As shown in FIG. 10B, the blanking interval can include at least one of a vertical blanking interval (VBI), a horizontal blanking interval (HBI), and a long horizontal blanking interval (LHBI). A time length of the LHBI is equal to or larger than a time length of the HBI. The LHBI can be obtained by redistributing a plurality of HBIs or the LHBI includes the VBI.

In practical applications, the common electrode of the in-cell mutual-capacitive touch panel of the invention can have only one common electrode region or a plurality of common electrode regions without any specific limitations.

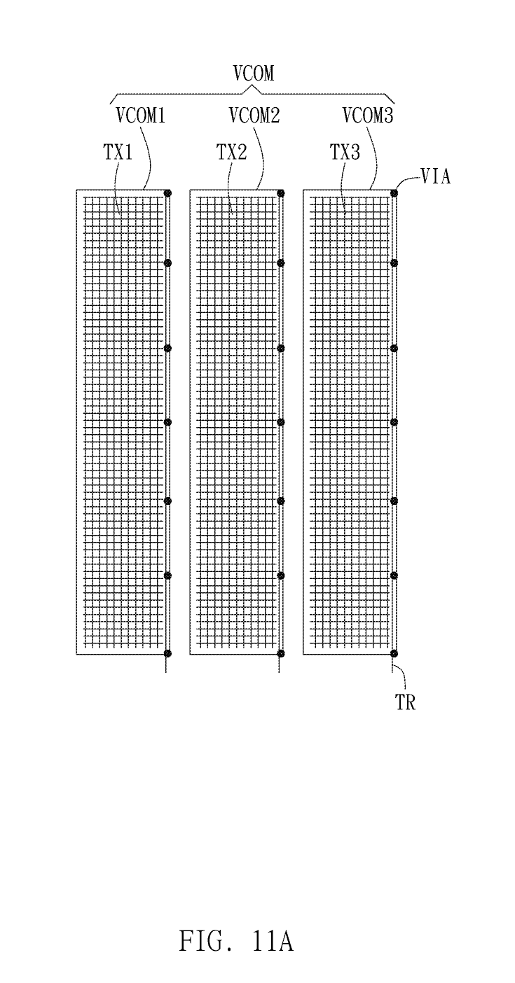

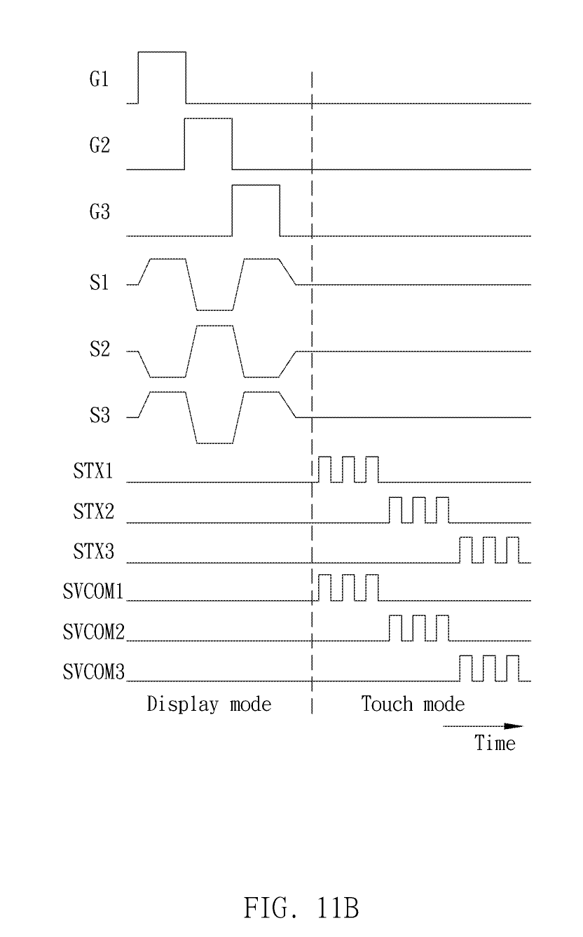

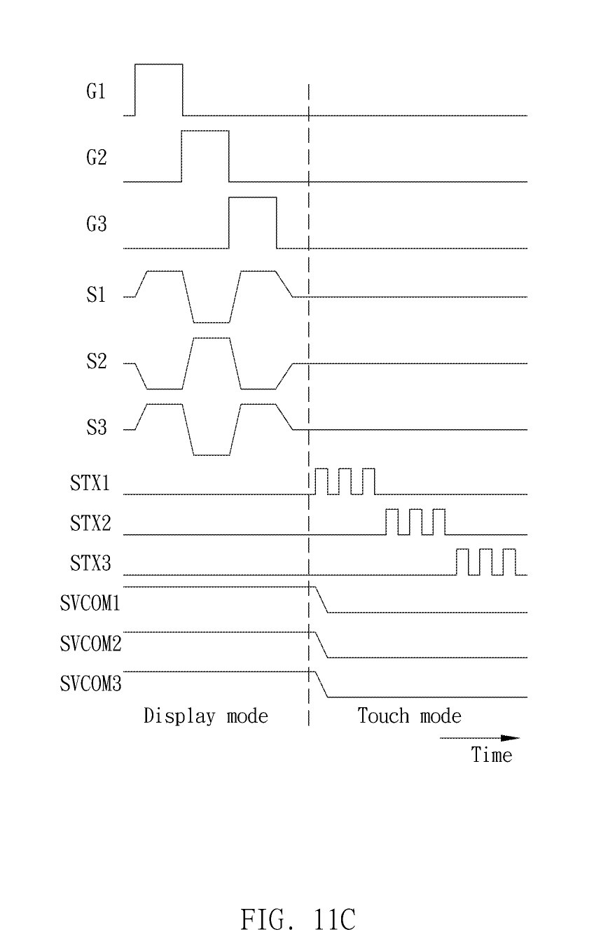

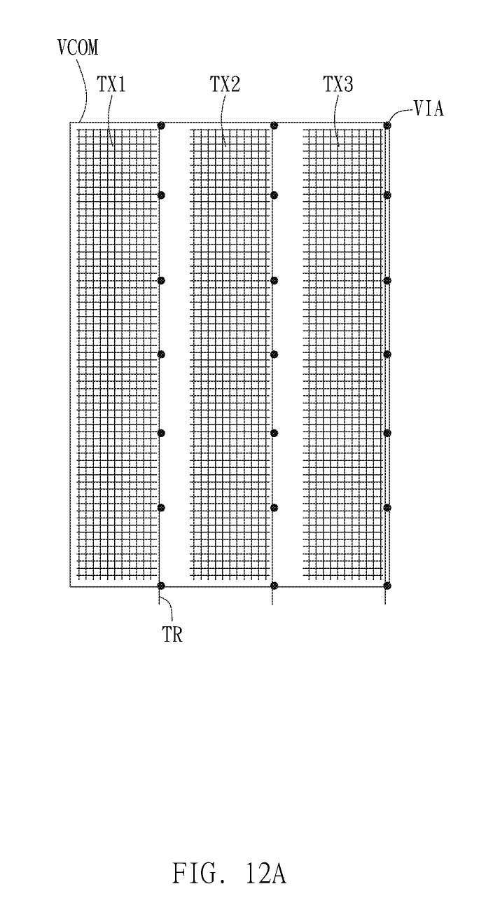

In an embodiment, as shown in FIG. 11A, the common electrode VCOM of the in-cell mutual-capacitive touch panel has a plurality of common electrode regions VCOM1˜VCOM3 overlapped with the plurality of touch electrodes TX1˜TX3 respectively. As shown in FIG. 11B and FIG. 11C, when the in-cell mutual-capacitive touch panel is operated in the display mode, its gate driver and source driver will output gate driving signals G1˜G3 and source driving signals S1˜S3 respectively to drive the pixels of the in-cell mutual-capacitive touch panel to display image; when the in-cell mutual-capacitive touch panel is operated in the touch mode, the plurality of touch electrodes TX1˜TX3 is provided a plurality of touch signals STX1˜STX3 in order and the plurality of common electrode regions VCOM1˜VCOM3 of the common electrode VCOM is provided a plurality of touch related signals SVCOM1˜SVCOM3 having the same frequency, the same amplitude or the same phase with the plurality of touch signals STX1˜STX3 in order correspondingly (as shown in FIG. 11B), or the plurality of common electrode regions VCOM1˜VCOM3 of the common electrode VCOM is all in the floating state (as shown in FIG. 11C).

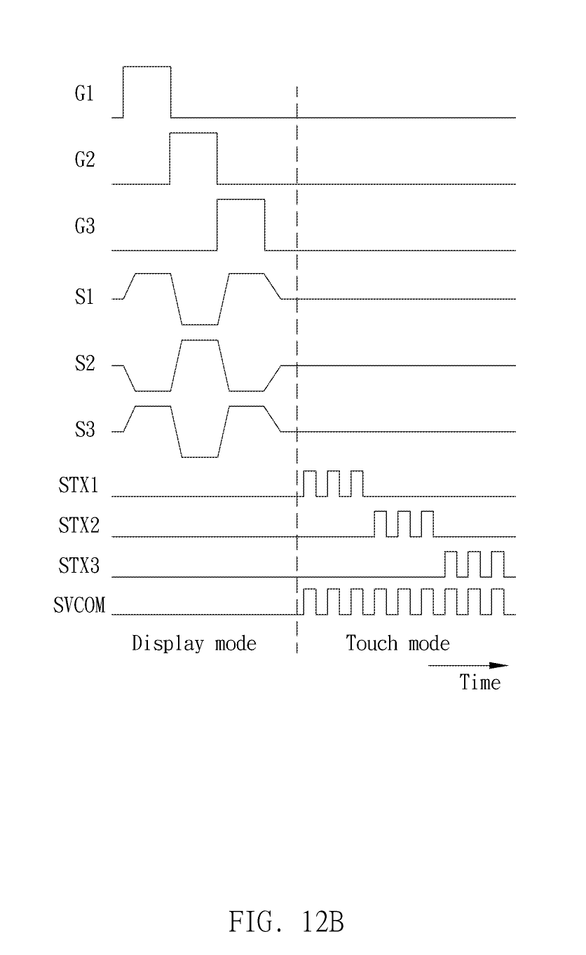

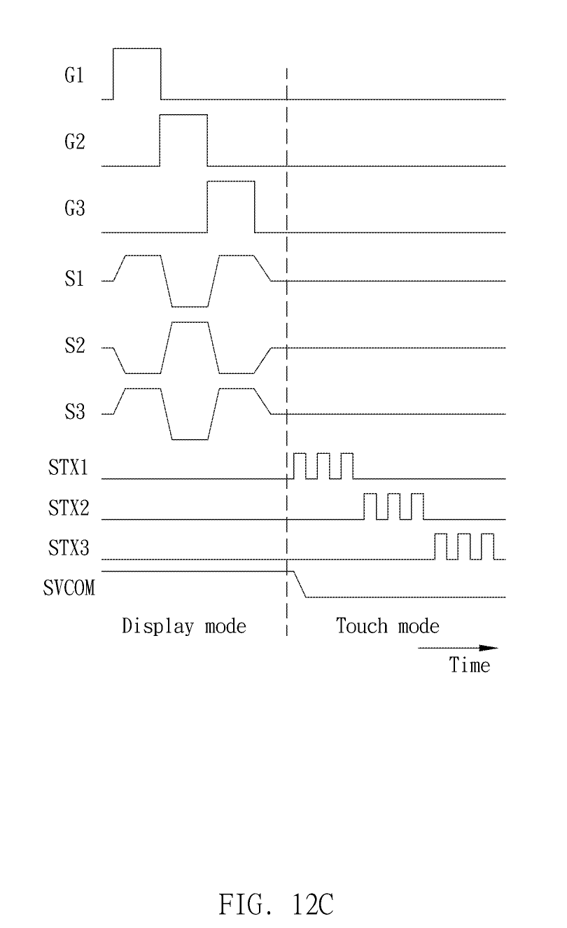

In another embodiment, as shown in FIG. 12A, the common electrode of the in-cell mutual-capacitive touch panel only has a common electrode region overlapped with the plurality of touch electrodes TX1˜TX3 simultaneously. As shown in FIG. 12B and FIG. 12C, when the in-cell mutual-capacitive touch panel is operated in the display mode, its gate driver and source driver will output gate driving signals G1˜G3 and source driving signals S1˜S3 respectively to drive the pixels of the in-cell mutual-capacitive touch panel to display image; when the in-cell mutual-capacitive touch panel is operated in the touch mode, the plurality of touch electrodes TX1˜TX3 is provided a plurality of touch signals STX1˜STX3 in order and the common electrode VCOM is provided a touch related signal SVCOM having the same frequency, the same amplitude or the same phase with the plurality of touch signals STX1˜STX3 (as shown in FIG. 12B), or the common electrode VCOM is in the floating state (as shown in FIG. 12C).

Compared to the prior arts, the in-cell touch panel of the invention has the following advantages and effects:
(1) Designs of the touch electrodes and their traces in the in-cell touch panel of the invention are simple.
(2) The original aperture ratio of the in-cell touch panel will not affected by the layout method of the invention.
(3) The RC loading of the common electrode can be reduced.
(4) When the in-cell touch panel is operated in touch mode, the common electrode is controlled simultaneously to reduce entire RC loading of the in-cell touch panel.
(5) The touch mode and the display mode of the in-cell touch panel are driven in a time-sharing way to enhance the signal-noise ratio (SNR).

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An in-cell touch panel, comprising:
a plurality of pixels, a laminated structure of each pixel comprising:
a substrate;
a thin-film transistor layer disposed on the substrate, wherein a first conductive layer and a common electrode are disposed in the TFT layer, and the first conductive layer is arranged in mesh type;
a liquid crystal layer disposed above the thin-film transistor layer;
a color filter layer disposed above the liquid crystal layer;
a glass layer disposed above the color filter layer; and
a second conductive layer disposed above the glass layer.

2. The in-cell touch panel of claim 1, wherein the in-cell touch panel is an in-cell mutual-capacitive touch panel, touch electrodes of the in-cell mutual-capacitive touch panel comprises a first direction electrode and a second direction electrode, the first direction electrode is formed by the first conductive layer arranged in mesh type and the second direction electrode is formed by the second conductive layer.

3. The in-cell touch panel of claim 1, wherein the second conductive layer is formed by transparent conductive material.

4. The in-cell touch panel of claim 1, wherein the first conductive layer is formed after the common electrode is formed.

5. The in-cell touch panel of claim 1, wherein the first conductive layer is formed before the common electrode is formed.

6. The in-cell touch panel of claim 1, wherein the color filter layer comprises a color filter and a black matrix resist, the black matrix resist has good light resistance, and the first conductive layer is disposed under the black matrix resist.

7. The in-cell touch panel of claim 1, wherein the thin-film transistor layer further comprises an original conductive layer; the original conductive layer is electrically connected with the common electrode to be traces of the common electrode to reduce RC loading of the common electrode.

8. The in-cell touch panel of claim 2, wherein the first direction electrode and the second direction electrode are a driving electrode (TX) and a sensing electrode (RX) respectively or the first direction electrode and the second direction electrode are the sensing electrode (RX) and the driving electrode (TX) respectively.

9. The in-cell touch panel of claim 2, wherein region dividing of the touch electrodes of the in-cell mutual-capacitive touch panel is determined by connection or disconnection of the first conductive layer.

10. The in-cell touch panel of claim 2, wherein a part of the first conductive layer not forming the first direction electrode is electrically connected with the common electrode to be traces of the common electrode to reduce RC loading of the common electrode.

11. The in-cell touch panel of claim 10, wherein the part of the first conductive layer not forming the first direction electrode is disposed in a vacancy region between the touch electrodes to be electrically connected with the common electrode.

12. The in-cell touch panel of claim 1, wherein a gate line and another gate line in the thin-film transistor layer are adjacently aligned at one side of the pixel.

13. The in-cell touch panel of claim 12, wherein a part of the first conductive layer not forming the first direction electrode or an original conductive layer in the thin-film transistor layer is disposed at another side of the pixel and electrically connected with the common electrode to be traces of the common electrode to reduce RC loading of the common electrode.

14. The in-cell touch panel of claim 2, wherein when the laminated structure has a half source driving (HSD) structure, the laminated structure comprises an additional vacated source line space.

15. The in-cell touch panel of claim 14, wherein an original conductive layer in the thin-film transistor layer is electrically connected with the first conductive layer within the additional vacated source line space to be traces of the first direction electrode.

16. The in-cell touch panel of claim 14, wherein an original conductive layer in the thin-film transistor layer is electrically connected with the common electrode within the additional vacated source line space to be traces of the common electrode to reduce RC loading of the common electrode.

17. The in-cell touch panel of claim 2, wherein a dummy electrode is disposed between the second direction electrodes formed by the second conductive layer, and the dummy electrode is in a floating state.

18. The in-cell touch panel of claim 1, wherein when the in-cell touch panel is operated in a touch mode, the common electrode is switched to a floating state or provided a touch related signal.

19. The in-cell touch panel of claim 1, wherein a touch mode and a display mode of the in-cell touch panel are driven in a time-sharing way; the in-cell touch panel is operated in the touch mode during a blanking interval of a display period.

20. The in-cell touch panel of claim 19, wherein the blanking interval comprises at least one of a vertical blanking interval (VBI), a horizontal blanking interval (HBI), and a long horizontal blanking interval (LHBI); a time length of the LHBI is equal to or larger than a time length of the HBI; the LHBI is obtained by redistributing a plurality of HBIs or the LHBI comprises the VBI.

21. The in-cell touch panel of claim 19, wherein the common electrode has a plurality of common electrode regions overlapped with a plurality of touch electrodes of the in-cell touch panel respectively; when the in-cell touch panel is operated in the touch mode, the plurality of touch electrodes is provided a plurality of touch signals in order and the common electrode is provided a plurality of touch related signals having the same frequency, the same amplitude or the same phase with the plurality of touch signals in order correspondingly or the common electrode is in a floating state.

22. The in-cell touch panel of claim 19, wherein the common electrode has a common electrode region overlapped with a plurality of touch electrodes of the in-cell touch panel simultaneously; when the in-cell touch panel is operated in the touch mode, the plurality of touch electrodes is provided a touch signal and the common electrode is provided a touch related signal having the same frequency, the same amplitude or the same phase with the touch signal or the common electrode is in a floating state.
